(19) United States
(12) Patent Application Publication
(10) Pub. No.: US 2016/0005129 A1
(43) Pub. Date: Jan. 7, 2016

(54) SELECTING INSURANCE COVERAGE BASED ON TRANSACTION DATA

(71) Applicant: MasterCard International Incorporated, Purchase, NY (US)

(72) Inventors: Pedro Chavarria, Hampton Bays, NY (US); Kristofer Perez, New York, NY (US)

(21) Appl. No.: 14/322,879

(22) Filed: Jul. 2, 2014

(51) Int. Cl. G06Q 40/08

(52) U.S. Cl. CPC G06Q 40/08

(57) ABSTRACT

Transaction data is mined to obtain a health profile for at least one person who wishes to select a medical insurance plan. The transaction data includes at least one of payment card transaction data and electronic bill presentment and payment transaction data. A database of insurance information is accessed to obtain information on cost and coverage for at least two medical insurance plans available to the at least one person who wishes to select the medical insurance plan. An optimal one of the at least two medical insurance plans is selected for the person who wishes to select the medical insurance plan, based on the health profile and the information on cost and coverage for the at least two medical insurance plans.

### FIELD OF THE DISCLOSURE

The present disclosure relates generally to the electronic and computer arts, and, more particularly, to apparatus and methods for analysis of electronic payment data.

### BACKGROUND OF THE DISCLOSURE

The use of payment cards, such as credit cards, debit cards, and pre-paid cards, has become ubiquitous. Most payment card accounts have one or more associated physical cards; however, the use of non-traditional payment devices, such as appropriately-configured “smart” cellular telephones, is increasing. A wealth of transaction data is available based on the use of payment card accounts.

The process of electronic bill presentment and payment has also been popular for quite some time. For example, U.S. Pat. No. 5,699,528 to Hogan (expressly incorporated herein by reference in its entirety for all purposes) discloses a system and method for bill delivery and payment over a communications network. In the bill delivery and payment system, users are able to access a server computer on a communications network to obtain bill information and pay bills.

Statistics is the study of the collection, organization, analysis, interpretation and presentation of data. Data mining includes the discovery of patterns in large data sets; for example, using aspects of artificial intelligence, machine learning, statistics, and database systems. Optimization involves the selection of the best element, with regard to some criteria, from some set of available alternatives. Decision trees are used in decision analysis to help identify a strategy most likely to reach a goal.

Individuals and/or family units may have available to them several possible choices for health insurance. For example, in the US, individuals may be offered coverage for themselves and their families from their employers, and may have multiple plans to choose from. In some jurisdictions, individuals may be covered by government health insurance, but may have the opportunity to purchase, for additional cost, private health insurance which provides additional coverage. Selection of the appropriate insurance plan may be confusing.

### SUMMARY OF THE DISCLOSURE

Principles of the disclosure provide techniques for selecting insurance coverage based on transaction data. In one aspect, an exemplary method includes the step of data mining transaction data to obtain a health profile for at least one person who wishes to select a medical insurance plan. The transaction data includes at least one of payment card transaction data and electronic bill presentment and payment transaction data. Further steps include accessing a database of insurance information to obtain information on cost and coverage for at least two medical insurance plans available to the at least one person who wishes to select the medical insurance plan; and selecting an optimal one of the at least two medical insurance plans for the person who wishes to select the medical insurance plan, based on the health profile and the information on cost and coverage for the at least two medical insurance plans.

In another aspect, another exemplary method includes the step of data mining transaction data to obtain a health profile for at least one person who wishes to estimate costs associated with a medical insurance plan. The transaction data includes at least one of payment card transaction data and electronic bill presentment and payment transaction data. Further steps include accessing a database of insurance information to obtain information on cost and coverage for the medical insurance plan; and estimating costs for the at least one person based on the health profile and the information on cost and coverage for the medical insurance plan.

Aspects of the disclosure contemplate the method(s) performed by one or more entities herein, as well as facilitating one or more method steps by the same or different entities. As used herein, “facilitating” an action includes performing the action, making the action easier, helping to carry the action out, or causing the action to be performed. Thus, by way of example and not limitation, instructions executing on one processor might facilitate an action carried out by instructions executing on a remote processor, by sending appropriate data or commands to cause or aid the action to be performed. For the avoidance of doubt, where an actor facilitates an action by other than performing the action, the action is nevertheless performed by some entity or combination of entities.

One or more embodiments of the disclosure or elements thereof can be implemented in the form of a computer program product including a tangible computer readable recordable storage medium with computer usable program code for performing the method steps indicated stored thereon in a non-transitory manner. Furthermore, one or more embodiments of the disclosure or elements thereof can be implemented in the form of a system (or apparatus) including a memory and at least one processor that is coupled to the memory and operative to perform exemplary method steps. Yet further, in another aspect, one or more embodiments of the disclosure or elements thereof can be implemented in the form of means for carrying out one or more of the method steps described herein; the means can include (i) specialized hardware module(s), (ii) software module(s) stored in a non-transitory manner in a tangible computer-readable recordable storage medium (or multiple such media) and implemented on a hardware processor, or (iii) a combination of (i) and (ii); any of (i)-(iii) implement the specific techniques set forth herein. Transmission medium(s) per se and disembodied signals per se are defined to be excluded from the claimed means.

One or more embodiments of the disclosure can provide substantial beneficial technical effects.

These and other features and advantages of the present disclosure will become apparent from the following detailed description of illustrative embodiments thereof, which is to be read in connection with the accompanying drawings.

### BRIEF DESCRIPTION OF THE DRAWINGS

FIG. 1 shows an example of a system and various components thereof that can implement techniques of the disclosure;

FIG. 2 depicts an exemplary inter-relationship between and among: (i) a payment network configured to facilitate transactions between multiple issuers and multiple acquirers, (ii) a plurality of users, (iii) a plurality of merchants, (iv) a plurality of acquirers, and (v) a plurality of issuers, as well as an exemplary database, useful in connection with one or more embodiments of the disclosure;

FIG. 3 is a block diagram of an exemplary system, in accordance with an aspect of the disclosure;

FIG. 4 shows an exemplary screen view wherein a user can pick his or her insurance plan(s) from pre-stored data, in accordance with an aspect of the disclosure;

FIG. 5 shows an exemplary screen view wherein a user can enter data on his or her insurance plan(s), in accordance with an aspect of the disclosure;

FIG. 6 illustrates exemplary decision tree analysis, in accordance with an aspect of the disclosure;

FIG. 7 is a block diagram of an exemplary computer system useful in one or more embodiments of the disclosure;

FIG. 8 shows exemplary operation of a bill pay system, in accordance with an aspect of the invention;

FIG. 9 shows exemplary operation of current automated clearinghouse payments;

FIG. 10 shows a screen shot of exemplary tool output, in accordance with an aspect of the invention; and

FIG. 11 is a flow chart of an exemplary method, in accordance with an aspect of the disclosure.

### DETAILED DESCRIPTION OF PREFERRED EMBODIMENTS

### Payment Devices and Associated Payment Processing Networks

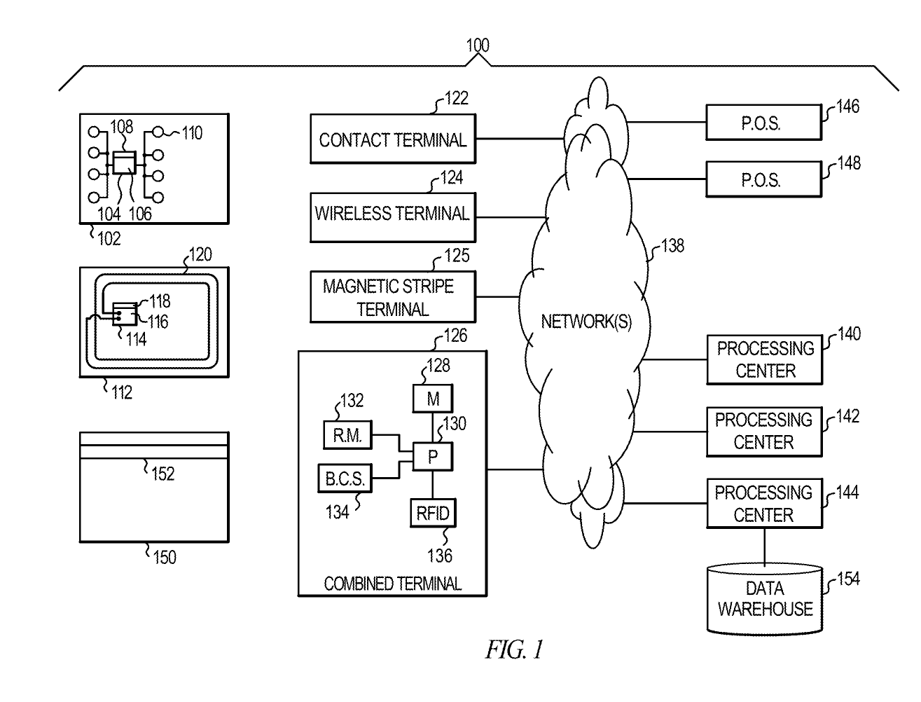

At least some embodiments use transaction data from payment card networks. Attention should now be given to FIG. 1, which depicts an exemplary embodiment of a system 100, according to an aspect of the disclosure, and including various possible components of the system. System 100 can include one or more different types of portable payment devices. For example, one such device can be a contact device such as card 102. Card 102 can include an integrated circuit (IC) chip 104 having a processor portion 106 and a memory portion 108. A plurality of electrical contacts 110 can be provided for communication purposes. In addition to or instead of card 102, system 100 can also be designed to work with a contactless device such as card 112. Card 112 can include an IC chip 114 having a processor portion 116 and a memory portion 118. An antenna 120 can be provided for contactless communication, such as, for example, using radio frequency (RF) electromagnetic waves. An oscillator or oscillators, and/or additional appropriate circuitry for one or more of modulation, demodulation, downconversion, and the like can be provided. Note that cards 102, 112 are exemplary of a variety of devices that can be employed. The system 100 per se may function with other types of devices in lieu of or in addition to “smart” or “chip” cards 102, 112; for example, a conventional card 150 having a magnetic stripe 152. Furthermore, an appropriately configured mobile device (e.g., “smart” cellular telephone handset, tablet, personal digital assistant (PDA), and the like) can be used to carry out contactless payments in some instances.

The ICs 104, 114 can contain processing units 106, 116 and memory units 108, 118. Preferably, the ICs 104, 114 can also include one or more of control logic, a timer, and input/output ports. Such elements are well known in the IC art and are not separately illustrated. One or both of the ICs 104, 114 can also include a co-processor, again, well-known and not separately illustrated. The control logic can provide, in conjunction with processing units 106, 116, the control necessary to handle communications between memory unit 108, 118 and the input/output ports. The timer can provide a timing reference signal from processing units 106, 116 and the control logic. The co-processor could provide the ability to perform complex computations in real time, such as those required by cryptographic algorithms.

The memory portions or units 108, 118 may include different types of memory, such as volatile and non-volatile memory and read-only and programmable memory. The memory units can store transaction card data such as, e.g., a user's primary account number (“PAN”) and/or personal identification number (“PIN”). The memory portions of units 108, 118 can store the operating system of the cards 102, 112. The operating system loads and executes applications and provides file management or other basic card services to the applications. One operating system that can be used to implement some aspects or embodiments of the present disclosure is the MULTOS® operating system licensed by MAOSCO Limited. (MAOSCO Limited, St. Andrews House, The Links, Kelvin Close, Birchwood, Warrington, WA3 7PB, United Kingdom) Alternatively, JAVA CARD™-based operating systems, based on JAVA CARD™ technology (licensed by Sun Microsystems, Inc., 4150 Network Circle, Santa Clara, Calif. 95054 USA), or proprietary operating systems available from a number of vendors, could be employed. Preferably, the operating system is stored in read-only memory (“ROM”) within memory portion 108, 118. In an alternate embodiment, flash memory or other non-volatile and/or volatile types of memory may also be used in the memory units 108, 118.

In addition to the basic services provided by the operating system, memory portions 108, 118 may also include one or more applications. At present, one possible specification to which such applications may conform is the EMV interoperable payments specification set forth by EMVCo, LLC (901 Metro Center Boulevard, Mailstop M3-3D, Foster City, Calif., 94404, USA). It will be appreciated that applications can be configured in a variety of different ways.

The skilled artisan will also be familiar with the MasterCard® PayPass™ specifications, available under license from MasterCard International Incorporated of Purchase, N.Y., USA (trademarks of MasterCard International Incorporated of Purchase, N.Y., USA).

As noted, cards 102, 112 are examples of a variety of payment devices that can be employed. The primary function of the payment devices may not be payment, for example, they may be cellular phone handsets that implement appropriate techniques. Such devices could include cards having a conventional form factor, smaller or larger cards, cards of different shape, key fobs, personal digital assistants (PDAs), appropriately configured cell phone handsets, or indeed any device with the appropriate capabilities. In some cases, the cards, or other payment devices, can include body portions (e.g., laminated plastic layers of a payment card, case or cabinet of a PDA, chip packaging, and the like), memories 108, 118 associated with the body portions, and processors 106, 116 associated with the body portions and coupled to the memories. The memories 108, 118 can contain appropriate applications. The processors 106, 116 can be operative to execute one or more steps. The applications can be, for example, application identifiers (AIDs) linked to software code in the form of firmware plus data in a card memory such as an electrically erasable programmable read-only memory (EEPROM).

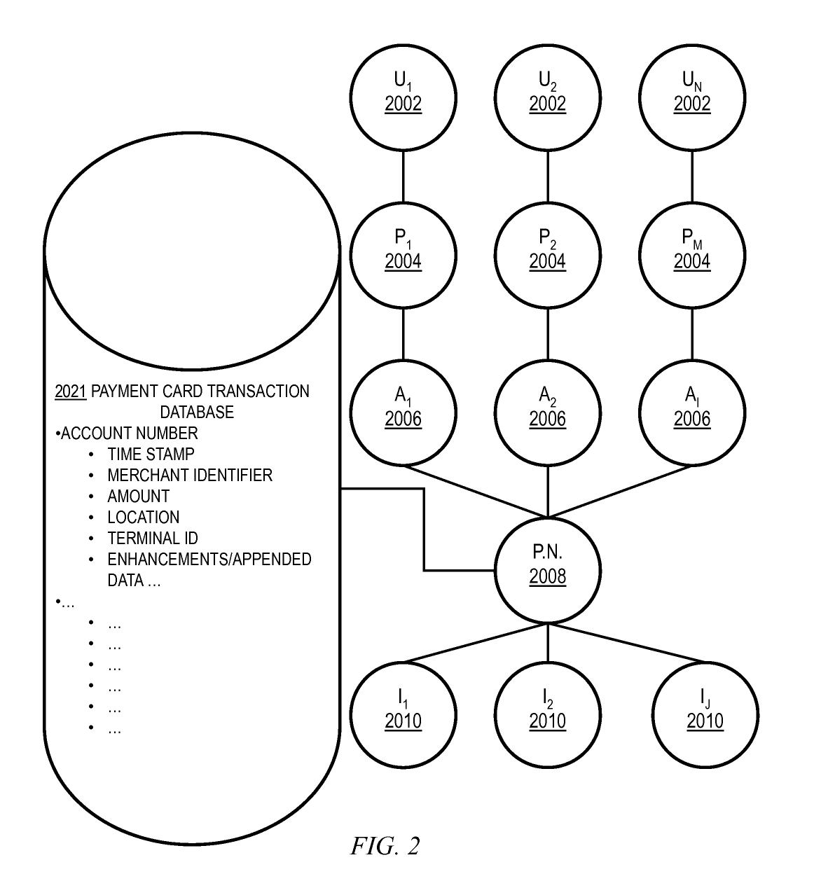

A number of different types of terminals can be employed with system 100. Such terminals can include a contact terminal 122 configured to interface with contact-type device 102, a wireless terminal 124 configured to interface with wireless device 112, a magnetic stripe terminal 125 configured to interface with a magnetic stripe device 150, or a combined terminal 126. Combined terminal 126 is designed to interface with any combination of devices 102, 112, 150. Some terminals can be contact terminals with plug-in contactless readers. Combined terminal 126 can include a memory 128, a processor portion 130, a reader module 132, and optionally an item interface module such as a bar code scanner 134 and/or a radio frequency identification (RFID) tag reader 136. Items 128, 132, 134, 136 can be coupled to the processor 130. Note that the principles of construction of terminal 126 are applicable to other types of terminals and are described in detail for illustrative purposes. Reader module 132 can, in general, be configured for contact communication with card or device 102, contactless communication with card or device 112, reading of magnetic stripe 152, or a combination of any two or more of the foregoing (different types of readers can be provided to interact with different types of cards e.g., contacted, magnetic stripe, or contactless). Terminals 122, 124, 125, 126 can be connected to one or more processing centers 140, 142, 144 via a computer network 138. Network 138 could include, for example, the Internet, or a proprietary network (e.g., a virtual private network (VPN) such as is described with respect to FIG. 2 below). More than one network could be employed to connect different elements of the system. For example, a local area network (LAN) could connect a terminal to a local server or other computer at a retail establishment or the like. A payment network could connect acquirers and issuers. Further details regarding one specific form of payment network will be provided below. Processing centers 140, 142, 144 can include, for example, a host computer of an issuer of a payment device.

Many different retail or other establishments, represented by points-of-sale 146, 148, can be connected to network 138. Different types of portable payment devices, terminals, or other elements or components can combine or “mix and match” one or more features depicted on the exemplary devices in FIG. 1.

Portable payment devices can facilitate transactions by a user with a terminal, such as 122, 124, 125, 126, of a system such as system 100. Such a device can include a processor, for example, the processing units 106, 116 discussed above. The device can also include a memory, such as memory portions 108, 118 discussed above, that is coupled to the processor. Further, the device can include a communications module that is coupled to the processor and configured to interface with a terminal such as one of the terminals 122, 124, 125, 126. The communications module can include, for example, the contacts 110 or antennas 120 together with appropriate circuitry (such as the aforementioned oscillator or oscillators and related circuitry) that permits interfacing with the terminals via contact or wireless communication. The processor of the apparatus can be operable to perform one or more steps of methods and techniques. The processor can perform such operations via hardware techniques, and/or under the influence of program instructions, such as an application, stored in one of the memory units.

The portable device can include a body portion. For example, this could be a laminated plastic body (as discussed above) in the case of “smart” or “chip” cards 102, 112, or the handset chassis and body in the case of a cellular telephone.

It will be appreciated that the terminals 122, 124, 125, 126 are examples of terminal apparatuses for interacting with a payment device of a holder. The apparatus can include a processor such as processor 130, a memory such as memory 128 that is coupled to the processor, and a communications module such as reader module 132 that is coupled to the processor and configured to interface with the portable apparatuses 102, 112, 150. The processor 130 can be operable to communicate with portable payment devices of a user via the reader module 132. The terminal apparatuses can function via hardware techniques in processor 130, or by program instructions stored in memory 128. Such logic could optionally be provided from a central location such as processing center 140 over network 138. The aforementioned bar code scanner 134 and/or RFID tag reader 136 can optionally be provided, and can be coupled to the processor, to gather attribute data, such as a product identification from a UPC code or RFID tag on a product to be purchased.

The above-described devices 102, 112 can be International Organization for Standardization (ISO) 7816-compliant contact cards or devices or NFC (Near Field Communications) or ISO 14443-compliant proximity cards or devices. In operation, card 112 can be touched or tapped on the wireless terminal 124 or reader module 132 (or an associated reader), which then contactlessly transmits the electronic data to the proximity IC chip in the card 112 or other wireless device.

One or more of the processing centers 140, 142, 144 can include a database such as a data warehouse 154.

In some instances, data from transactions with pharmacies (in general, both “brick and mortar” pharmacies or online pharmacies) may be pertinent.

In some cases, there can be payment card accounts that do not have physical cards or other physical payment devices associated therewith; for example, a customer can be provided with a PAN, expiration date, and security code, but no physical payment device, and use same, for example, for card-not-present telephone or internet transactions. Transaction data for such accounts is also pertinent in one or more embodiments.

With reference to FIG. 2, an exemplary relationship among multiple entities is depicted. A number of different users (e.g., consumers) 2002, U₁, U₂ . . . U_{N}, interact with a number of different merchants 2004, P₁, P₂ . . . P_{M}. Merchants 2004 interact with a number of different acquirers 2006, A₁, A₂ . . . A_{I}. Acquirers 2006 interact with a number of different issuers 2010, I₁, 1₂ . . . I_{J}, through, for example, a single operator of a payment network 2008 configured to facilitate transactions between multiple issuers and multiple acquirers; for example, MasterCard International Incorporated, operator of the BANKNET® network, or Visa International Service Association, operator of the VISANET® network. In general, N, M, I, and J are integers that can be equal or not equal.

During a conventional credit authorization process, the consumer 2002 pays for the purchase and the merchant 2004 submits the transaction to the acquirer (acquiring bank) 2006. The acquirer verifies the card number, the transaction type and the amount with the issuer 2010 and reserves that amount of the cardholder's credit limit for the merchant. At this point, the authorization request and response have been exchanged, typically in real time. Authorized transactions are stored in “batches,” which are sent to the acquirer 2006. During subsequent clearing and settlement, the acquirer sends the batch transactions through the payment card network 2008, which debits the issuers 2010 for payment and credits the acquirer 2006. Once the acquirer 2006 has been paid, the acquirer 2006 pays the merchant 2004.

Payment card transaction database 2021 is discussed below.

It will be appreciated that the payment card network 2008 shown in FIG. 2 is an example of a payment network configured to facilitate transactions between multiple issuers and multiple acquirers, which may be thought of as an “open” system. Some embodiments of the disclosure may be employed with other kinds of payment networks, for example, proprietary or closed payments networks with only a single issuer and acquirer. Furthermore in this regard, FIG. 2 depicts a four party model, as will be known to the skilled artisan; the four parties are the consumer 2002, merchant 2004, acquirer 2006, and issuer 2010. However, at least some embodiments are also of use with three-party models, wherein the acquirer and issuer are the same entity.

Messages within a network such as network 138 and/or network 2008, may, in at least some instances, conform to the ISO Standard 8583, Financial transaction card originated messages—Interchange message specifications, which is the ISO standard for systems that exchange electronic transactions made by cardholders using payment cards. It should be noted that the skilled artisan will be familiar with the ISO 8583 standards. Nevertheless, out of an abundance of caution, the following documents are expressly incorporated herein by reference in their entirety for all purposes (published by ISO, Geneva, Switzerland, and available on the ISO web site):
ISO 8583 Part 1: Messages, data elements and code values (2003)
ISO 8583 Part 2: Application and registration procedures for Institution Identification Codes (IIC) (1998)
ISO 8583 Part 3: Maintenance procedures for messages, data elements and code values (2003)
ISO 8583:1993 (1993)
ISO 8583:1987 (1987)

As used herein, a “payment card network” is a communications network that uses payment card account numbers, such as primary account numbers (PANs), to authorize, and to facilitate clearing and settlement of, payment card transactions for credit, debit, stored value and/or prepaid card accounts. The card accounts have standardized payment card account numbers associated with them, which allow for efficient routing and clearing of transactions; for example, ISO standard account numbers such as ISO/IEC 7812-compliant account numbers. The card accounts and/or account numbers may or may not have physical cards or other physical payment devices associated with them. For example, in some instances, organizations have purchasing card accounts to which a payment card account number is assigned, used for making purchases for the organization, but there is no corresponding physical card. In other instances, “virtual” account numbers are employed; this is also known as PAN mapping. The PAN mapping process involves taking the original Primary Account Number (PAN) (which may or may not be associated with a physical card) and issuing a pseudo-PAN (or virtual card number) in its place. Commercially available PAN-mapping solutions include those available from Orbiscom Ltd., Block 1, Blackrock Business Park, Carysfort Avenue, Blackrock, Co. Dublin, Ireland (now part of MasterCard International Incorporated of Purchase, N.Y., USA); by way of example and not limitation, techniques of U.S. Pat. Nos. 6,636,833 and 7,136,835 of Flitcroft et al., the complete disclosures of both of which are expressly incorporated herein by reference in their entireties for all purposes. It is worth noting that in one or more embodiments, single use PANS are only valuable to the extent that they can be re-mapped to the underlying account, cardholder, or household.

Some payment card networks connect multiple issuers with multiple acquirers; others use a three party model. Some payment card networks use ISO 8583 messaging. Non-limiting examples of payment card networks that connect multiple issuers with multiple acquirers are the BANKNET® network and the VISANET® network.

### Electronic Bill Presentment and Payment Systems

At least some embodiments use transaction data from electronic bill payment systems (optionally, with presentment functionality). Electronic bill payment systems are conceptually different than payment card networks, and will often use electronic funds transfer (EFT) from a demand deposit account. In some instances, a single entity, such as MasterCard International Incorporated (a non-limiting example) will operate both a payment card network and an electronic bill payment system (optionally, with presentment functionality).

With regard to electronic bill presentment and payment systems, inventive techniques can be employed in a number of different environments. In one or more embodiments, inventive techniques can be employed in connection with the MASTERCARD RPPS® electronic payment system of MasterCard International Incorporated of Purchase, N.Y., USA. This example is non-limiting; for example, other types of electronic bill presentment and/or payment systems could be employed in other instances. Further non-limiting examples are described in:
US Patent Publication 2011-0251952 A1 of Mary L. Kelly et al.
US Patent Publication 2012-0197788 A1 of Hemal Sanghvi et al.

The above-listed Kelly and Sanghvi publications are hereby expressly incorporated by reference herein in their entireties for all purposes.

For the avoidance of doubt, references to MasterCard, unless expressly stated to be limited to MasterCard, are intended to be exemplary of an operator of an electronic bill payment system (optionally, with presentment functionality) and/or an operator of a payment card network, as will be appreciated from the context, whether or not qualified by words such as “or other operator.”

Furthermore, another non-limiting example of electronic bill presentment and/or payment systems with which one or more embodiments of the invention can be employed is the CHECKFREE platform available from Fiserv, Inc. of Brookfield, Wis., USA.

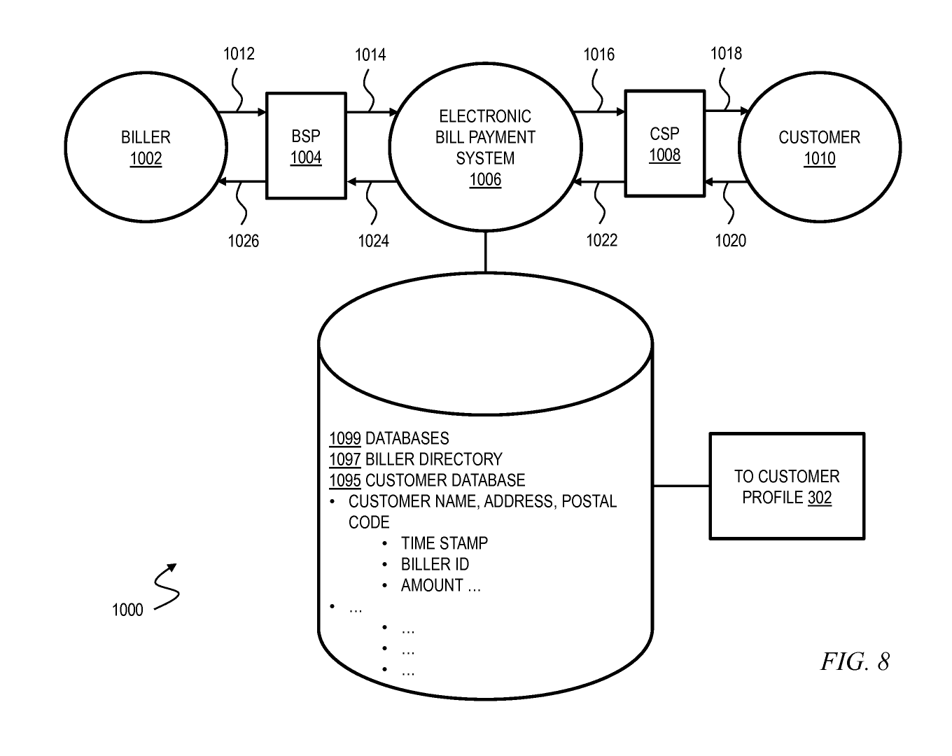

FIG. 8 shows operation of an electronic bill payment system, such as the MASTERCARD RPPS® electronic payment system, which is but one non-limiting example of such a system, modified in accordance with aspects of the invention. Given the teachings herein, the skilled artisan will be able to implement one or more embodiments of the invention using a variety of techniques; by way of example and not limitation, the modification or supplementing of an existing MASTERCARD RPPS® system or other electronic payment system as shown in FIG. 8. As shown in FIG. 8, in an approach 1000, during a presentment phase, a biller 1002 electronically sends billing information 1012 to its biller service provider (BSP) 1004; that is, an institution that acts as an intermediary between the biller and the consumer for the exchange of electronic bill payment information. BSP 1004 in turn sends the information to the electronic bill payment system 1006, as seen at 1014. As seen at 1016, the system 1006 in turn delivers the billing information to the customer service provider (CSP) 1008; that is, an agent of the customer that provides an interface directly to customers, businesses, or others for bill payment and presentment. The CSP enrolls customers, enables payment and presentment, and provides customer care. CSP 1008 presents the bill to the consumer (customer) 1010 at 1018.

In a payment phase, consumer 1010 sends bill payment instructions to CSP 1008, as seen at 1020. CSP 1008 in turn sends the bill payment information to the system 1006, as at 1022. The system sends funds and data electronically to BSP 1004, as at 1024. The BSP 1004 posts payment information to the biller 1002, as at 1026.

System 1006 typically includes one or more database(s) 1099; for example, a database 1097 known as a biller directory or the like, and a customer database 1095. The skilled artisan will be familiar with biller directory and customer databases per se; one non-limiting example of a biller directory database is the MASTERCARD® RPPS® BILLER DIRECTORY product (registered marks of MasterCard International Incorporated, Purchase, N.Y., USA). Such a biller directory typically allows someone who wishes to pay bills with system 1006 to search for the desired biller (payee) by company name, category, ZIP (or other postal) code, and the like. Such a biller directory can include, for example, a record for each biller including company name, merchant category code (MCC) or other category, or ZIP (or other postal) code, a unique Biller ID, bank account information regarding which bank account Automated Clearing House (ACH) payments are to be routed to, and so on. Companies with multiple locations may have separate database entries for each location or an additional field may be used to designate different locations within a company, for example. Each customer 1010 may have records in customer database 1095. These records may show the customer's name, address, and ZIP or other postal code. Many transactions, including, for each transaction, a time stamp, biller ID, and amount, will be associated with each customer. The ellipses indicate that each customer has many transactions, and that there are many customers. Data in databases 1099 can be used to create a customer profile 302 as discussed further below.

Note that “BPPS” is used herein as shorthand for an electronic “bill presentment and payment system”; the RPPS system is a non-limiting example of such a system.

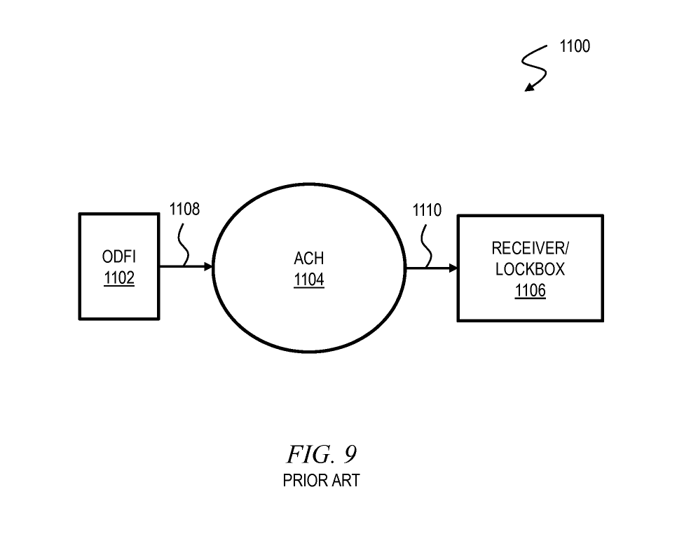

FIG. 9 shows a current process 1100 for making electronic funds transfers (EFT) for bill payment or the like. An originating depository financial institution (ODFI) 1102, also known as an originator, sends instructions (e.g., payment data and remittance data) using a network such as the automated clearing house (ACH) 1104, Swift, EPN, CHIPS, Fedwire, and the like, as seen at 1108. As shown at 1110, the ACH or similar network 1104 relays the instructions to the receiving depository financial institution (RDFI) (e.g., receiver or a lockbox), designated 1106. In some embodiments, an ACH file format can be used; one non-limiting example of an ACH file format is the NACHA ACH CCD file format. Other formats can also be used; for example, extensible markup language (XML). It should be noted that a variety of networks can be used, both public (for example, ACH) and proprietary (for example, the aforementioned MASTERCARD RPPS system).

### Insurance Coverage Selection

In jurisdictions such as the United States, when people have a new employer, they will typically need to change health insurance plans; this process usually involves selecting from among several plans. Even persons remaining at the same employer typically need to re-select their insurance each year. Most people are not very knowledgeable about what plans are available and which plan is best for them. One or more embodiments advantageously use transaction data, such as payment card transaction data and/or electronic bill presentment and payment transaction data to characterize an individual (in the case of payment card transaction data, the individual cardholder) in a manner which provides health-related insights which assist in selection of an appropriate insurance plan. For example, from transaction data, it can be determined whether the cardholder travels a lot, whether he or she engages in a significant number of risky activities (e.g., extreme skiing, mountaineering, skydiving); whether he or she frequently needs prescription medicine; whether he or she has a lot of allergies or other conditions that require more frequent doctor and/or hospital visits or other medical care; and the like.

In one or more embodiments, information gleaned from the transaction data is used to help pick an appropriate, or even optimal, insurance plan for that cardholder. Frequently, the person choosing the plan may not know what different available plans cover. A healthy young person may just need a plan that covers an annual checkup and occasional doctor visits and/or small amounts of prescription medicine for occasional acute problems. Individuals who need a lot of prescription medicines for chronic conditions, but who seldom visit the doctor (e.g., perhaps only for infrequent periodic monitoring of the chronic conditions) may want a different plan with a low pharmacy co-pay. People with school-age children may anticipate very frequent pediatrician visits for easily communicable infectious diseases and may want good coverage, with a low co-pay amount, for same.

Referring now to payment card transaction database 2021 in FIG. 2, in one or more embodiments, this database includes raw transaction data from every transaction in a payment card network (BANKNET and VISANET are non-limiting examples; i.e., database 2021 may include a plurality of records for a plurality of different account numbers (PANs) for a single brand of payment card products). There is typically a record for each transaction, including the PAN, time stamp (date and time of transaction), amount, and some type of identification for the merchant, such as business name and/or predefined industry definition (e.g., merchant category code (MCC)). The ellipses indicate that each PAN has many transactions, and that there are many PANs. Note that transaction frequency can be derived from the time stamp data. Note also that merchant location, where pertinent (e.g., to infer cardholder travel), can be determined from the merchant identifier and/or associated records. Residence of the person buying insurance can be determined by querying the person. Any other appropriate information can also be included in the transaction record; e.g., location, ID of the terminal where the transaction took place, any enhanced or appended data that may be appropriate, and the like.

Referring now to databases 1099 in FIG. 8, in one or more embodiments, from biller directory 1097, determine the Biller IDs of the billers 1002 that are possibly pertinent to insurance plan selection. Then, query database 1095 to return all transactions for the customer(s) of interest that are payments to the biller IDs of the billers 1002 that are possibly pertinent to insurance plan selection. The records for these transactions are used to develop customer profiles 302 in one or more embodiments.

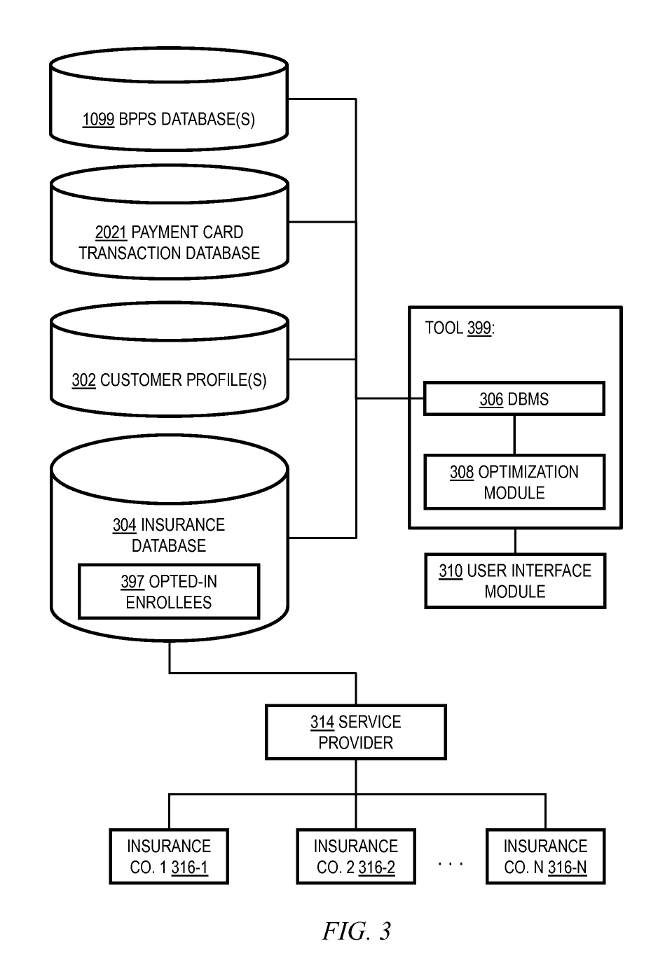

Continuing to refer to FIGS. 2 and 8, and referring now also to FIG. 3, in one or more embodiments, data mining is carried out on the raw data in databases 2021 and/or 1099 (e.g., 1097 and/or 1095). For example, an individual may provide one or more PANs associated with one or more of his or her payment card accounts, and database 2021 may be queried for transactions by those PAN(s) (e.g., with database management system (DBMS) 306), to develop a profile 302 of an individual, and/or queries are carried out on databases 1095 and/or 1097 as described just above. Within transactions for those PAN(s) or customer(s), transactions having potential health-related significance can be identified via appropriate queries. Examples of such transactions include transactions with health-care providers such as doctors, hospitals, or pharmacies, or lifestyle-related transactions which provide some indication of likely future medical needs. As noted above, from transaction data, it can be determined whether the cardholder travels a lot, whether he or she engages in a significant number of risky activities; whether he or she frequently needs prescription medicine; whether he or she has a lot of allergies or other conditions that require more frequent doctor and/or hospital visits or other medical care; and the like. Someone fond of extreme helicopter skiing may want a health plan with good orthopedic coverage (e.g., widely accepted by orthopedists, low co-pay for specialists, no referral from primary care doctor required). One or more embodiments use Structured Query Language (SQL) queries or other appropriate database capability to delve into the raw data in database 2021 and/or 1099 (e.g., 1097 and/or 1095) and build tables or other data structures in the form of a customized database 302 for the individual subject, on which various further queries can be carried out. Of course, if desired, operations could simply be carried out directly on the raw data 2021 and/or 1099 (e.g., 1097 and/or 1095) without developing separate customer profiles.

Merchants with possible relevance to health can be determined, for example, by business names, merchant identifier, and/or by a predefined industry definition (e.g., merchant category code (MCC)) as discussed above. That is to say, in one or more embodiments, a determination is made regarding which merchants having transaction data in database 2021 and/or 1099 (e.g., 1097 and/or 1095) have a potential correlation with a subject's health. The correlation can be positive (e.g., health food stores, gyms) or negative (e.g., fast food stores, stores catering to smokers). Some merchants may not have any correlation to a subject's (e.g., merchants selling dress clothing).

In a non-limiting example, as part of the data mining on the payment card transaction database 2021, a query is run for entries in database 2021 for the PAN(s) corresponding to the account(s) to be analyzed (e.g., one or more accounts of the subject who wishes to select an insurance plan) and/or in database 1099 (e.g., 1097 and/or 1095) for the customer transaction records of the subject. Optionally, the query is limited to transactions with time stamps falling within a date range of interest (e.g., Jan. 1, 2015-Dec. 31, 2015). In some cases, large ranges of dates or even all available past data can be analyzed. In some instances, more recent data can be given a higher weight in developing a profile of aspects of the user related to health plan selection. Queries can be designed, for example, to identify transactions where the business name, merchant identifier, and/or MCC matches a list of business names, merchant identifiers, and/or MCCs believed to be pertinent to health plan selection.

It is worth noting that in some cases, the records in database 2021 do not include any information that allows for identifying the cardholder associated with the PAN, and/or contractual or other obligations do not permit access or use of such information. In such cases, the issuing bank typically has this information. Thus, in at least some cases, an operator of a payment card network such as 2008 offers a service to the issuer, who makes the insurance selection tool available to the actual cardholder. Note, however, that this is a non-limiting example. In other instances for example, in cases of express cardholder opt-in (e.g., when voluntarily providing one or more PANs associated with his or her accounts, in order to use the service) or other form of express cardholder consent, the records in database 2021 do permit identifying the cardholder associated with the PAN.

Once the data mining on the transaction data 2021 and/or 1099 (e.g., 1097 and/or 1095) has been carried out (obtaining, e.g., a lifestyle profile for the subject, stored in profile database 302), the results are used, in conjunction with data characterizing available insurance plans (stored in insurance database 304), to assist the subject in picking the right insurance plan. In some instances, obtain data (e.g., coverage, costs) on all the insurance plans that are available in a jurisdiction of interest (for example, by querying the insurance companies) and collect this information in database 304. In a non-limiting example, a service provider 314 (which could be, but need not be, the operator of a payment network 2008) collects the required data from insurance companies 1 through N numbered 316-1 through 316-N, and stores same in database 304.

In one or more embodiments, inquire of the subject (person seeking to pick an insurance plan for himself or herself or for his or her family) what insurance carriers the subject's company provides to him or her. Typically, this will result in a limited number of available options (say, by way of example and not limitation, 4 or 5 available options). In an alternative approach, the subject is prompted to provide information about the insurance choices available to him or her. In either case, interaction with the subject can be, for example, via user interface module 310, discussed further below.

Furthermore with regard to the first approach, wherein insurance plan information is obtained directly from the insurance companies 316-1 through 316-N, in some such cases, a service provider 314 builds a relationship with all the medical insurers in the jurisdiction of interest (e.g., US or one or more of the states thereof) and asks the insurers to provide a report with all of their plans and coverage. This information can be refreshed every time each company changes their plans (for example, once a year). Once the insurance database 304 is set, the user can employ a tool 399 in accordance with one or more embodiments of the invention, pick the insurance companies available to him or her (e.g., from his or her employer), and select the plans available to him or her from those companies. With this information, one or more embodiments run an analysis in the background to compare the user's profile to the insurance options and come up with the optimal choice (e.g., using optimization module 308 discussed further below).

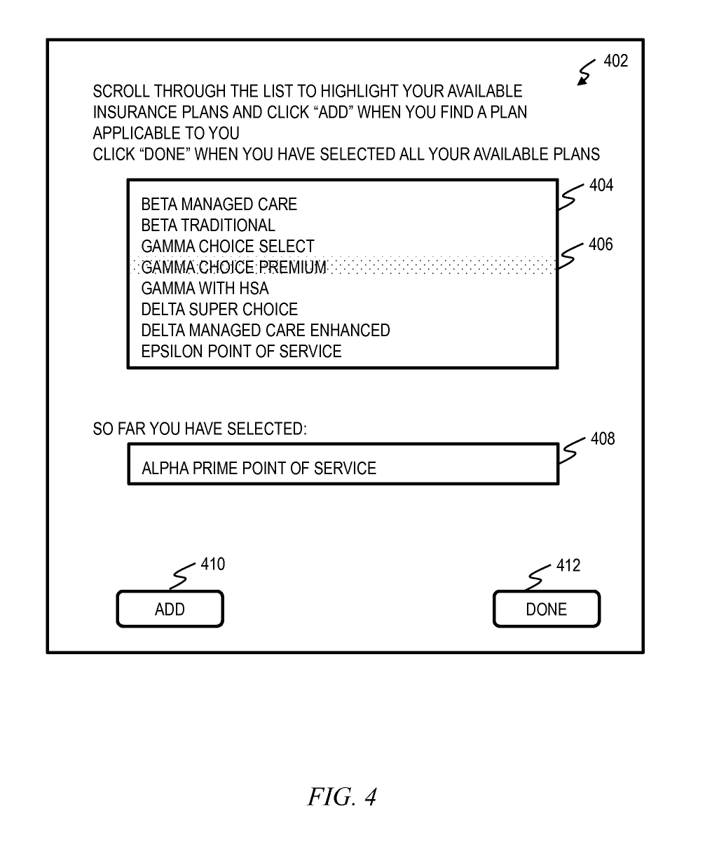

FIG. 4 shows a screen shot for the first approach. The UI module 310 can serve out HTML to a browser program on a machine (e.g. system 700 discussed below) of a subject, to create a screen such as that shown in FIG. 4. At 402, the user is invited to scroll through a list 404 to highlight those insurance plans available to him or her from his or her employer (or otherwise). Here “Gamma Choice Premium” is currently highlighted as seen at 406. If “Gamma Choice Premium” is one of the options available to the user, he or she clicks on “ADD” button 410 to add “Gamma Choice Premium” to the list of available options 408 (currently, the user has only selected “Alpha Prime Point of Service”). If “Gamma Choice Premium” is not one of the options available to the user, he or she continues to scroll through the list 404. When all available plans of interest have been added to the list 408, the user clicks the “DONE” button 412.

Furthermore with regard to the alternative approach, in that aspect, the user simply inputs the information regarding the insurance plans he or she has available to him or her into the system; for example, using a template where the user inputs the name of the insurance companies, the plans, the co-pays, the coverage, and so on. This information can be input, for example, via user interface module 310. In this alternative approach, with the user-input insurance information, one or more embodiments match the user's profile to the user-input insurance options and determine the optimal choice (e.g., using optimization module 308 discussed further below).

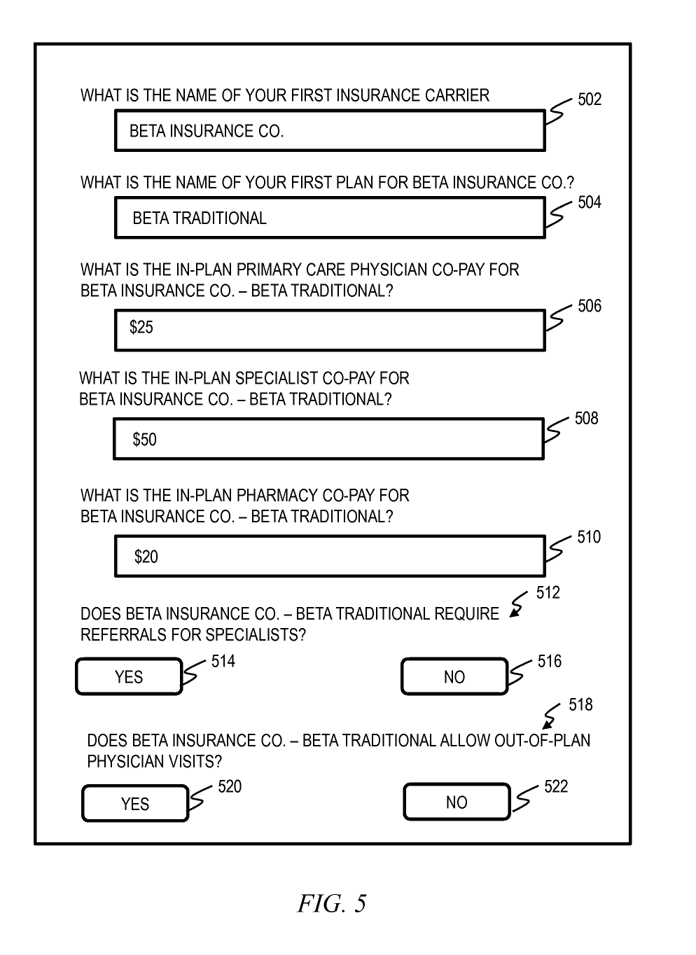

FIG. 5 shows a screen shot for the alternative approach. It should be appreciated that not all the elements shown in FIG. 5 may appear on a user's screen all at once, and that other embodiments may include more, fewer, or different user queries. In the non-limiting example of FIG. 5, at 502, the user is queried for the name of his or her first available insurance carrier; here, “Beta Insurance Co.” At 504, the user is queried for the name of his or her first available insurance plan from that insurance carrier; here, “Beta Traditional.” At 506, 508, and 510, he or she is respectively prompted to enter the co-pay for the primary care physician, for specialists, and for pharmacy items, for this plan. At 512, he or she is asked whether the plan requires referrals for specialists, and can respond by clicking “YES” or “NO” buttons 514, 516 as the case may be. At 518, he or she is asked whether the plan allows out-of-plan physician visits, and can respond by clicking “YES” or “NO” buttons 520, 522 as the case may be. Other non-limiting examples of information that can be gathered include hospitalization costs, what percentage is covered if out-of-plan visits are allowed, whether overseas coverage is provided, and so on. Queries can be continued for all other available carriers and plans; any suitable technique can be used to determine whether there are more available plans or whether all required information has been entered (e.g., an “ENTER ANOTHER PLAN” button and a “DONE” button (omitted to avoid clutter).

Having both options available allows the system to have all the most accurate information from insurance companies as well as allowing customers to add customized coverage.

In one or more embodiments, the types of medical spending most likely for the given subject, e.g., hospital, are predicted based on the transaction data and then used to make a suitable selection from the available insurance plans.

Some embodiments further analyze available enrollment data to see which available plans have the most enrollees who are similar to the subject; e.g., if the subject's lifestyle profile identifies him or her as an amateur athlete; look for the available plan with the most athletes enrolled; if the subject's lifestyle profile identifies him or her as frequently needing prescription drugs; look for the available plan with the most frequent prescription drug users enrolled. In this aspect, other enrolled individuals expressly opt in to allowing their data to be used to help subjects pick plans. Data associated with these opted-in individuals is shown at 397 within database 304.

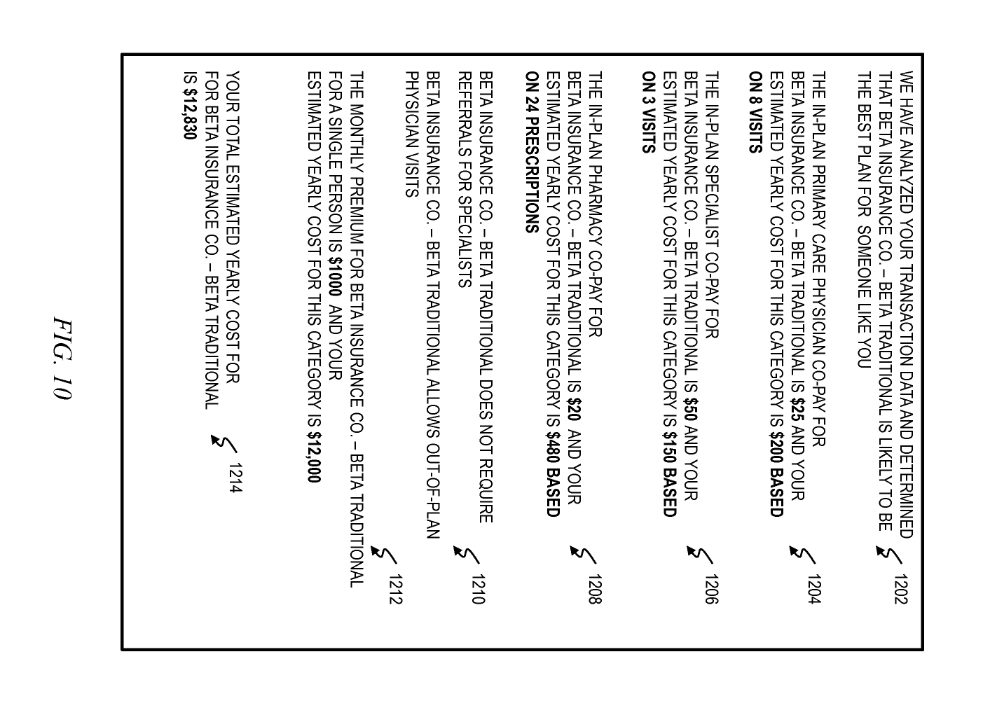

Regardless of whether available enrollment data from opted-in enrolled individuals is analyzed to see which available plans have the most enrollees who are similar to the subject, the results of the overall analytical process are presented to the user (e.g., with module 310), comparing benefits and costs for the available plans. As seen in FIG. 10, at 1202, an indication may be provided such as “we have analyzed your transaction data and determined that Beta Insurance Co.—Beta Traditional is likely to be the best (available) plan for someone like you.” At 1204, it is indicated that Beta Traditional has a $25 copay for an in-plan primary care physician, and that based on the subject's estimated 8 annual visits, the total cost is likely to be $200. The estimate of 8 annual visits could be based on the number of visits in the past year, or an average (possibly weighted) of visits over a number of previous years. At 1206, it is indicated that Beta Traditional has a $50 copay for an in-plan specialist physician, and that based on the subject's estimated 3 annual visits, the total cost is likely to be $150. Again, the estimate of 3 annual visits could be based on the number of visits in the past year, or an average (possibly weighted) of visits over a number of previous years. At 1208, it is indicated that Beta Traditional has a $20 per prescription pharmacy copay, and that based on the subject's estimated 24 annual prescriptions, the total cost is likely to be $480. The estimate of 24 annual prescriptions could be based on the number of prescriptions in the past year, or an average (possibly weighted) of prescriptions over a number of previous years. At 1210 it is indicated that Beta Traditional does not require referrals for specialists and allows out-of-plan physician visits. At 1212, the monthly premium for the subject is shown along with the estimated yearly cost. At 1214, the total estimated yearly cost is shown.

Of course, FIG. 10 provides a non-limiting example. Other information could be shown if desired; for example, the daily copay for hospitalization and estimated annual amount; the fact that the plan covers insured persons when travelling outside the country; a statement calling the subject's attention to the fact that his or her transaction data shows an interest in extreme helicopter skiing and that Beta Traditional is accepted by 95% of prominent orthopedic surgeons, and so on.

In one or more embodiments, a database program 306 queries a transaction database 2021 and/or 1099 (e.g., 1097 and/or 1095) (and/or database 302 derived from same) and an insurance database 304, and then an optimization module 308 solves the optimization problem to determine an appropriate, and even optimal, plan selection for a given subject. Tool 399 includes the DBMS 306 and optimization module 308. UI module 310 communicates with tool 399.

It will be appreciated that in some instances, embodiments of the invention create groups of people; match those people with what insurance they have; and carry out an optimization process.

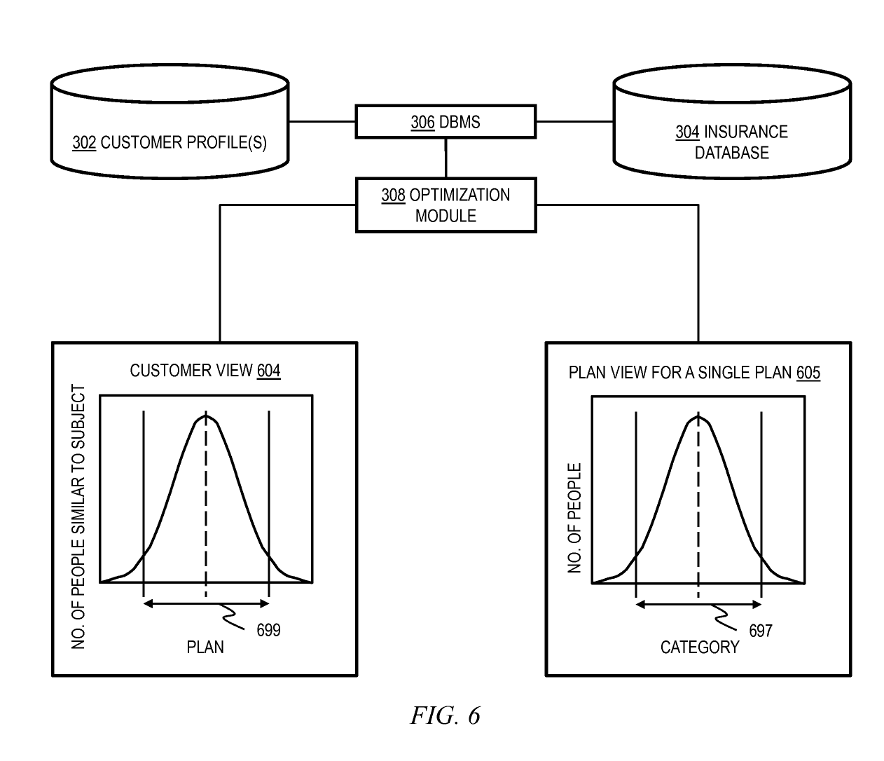

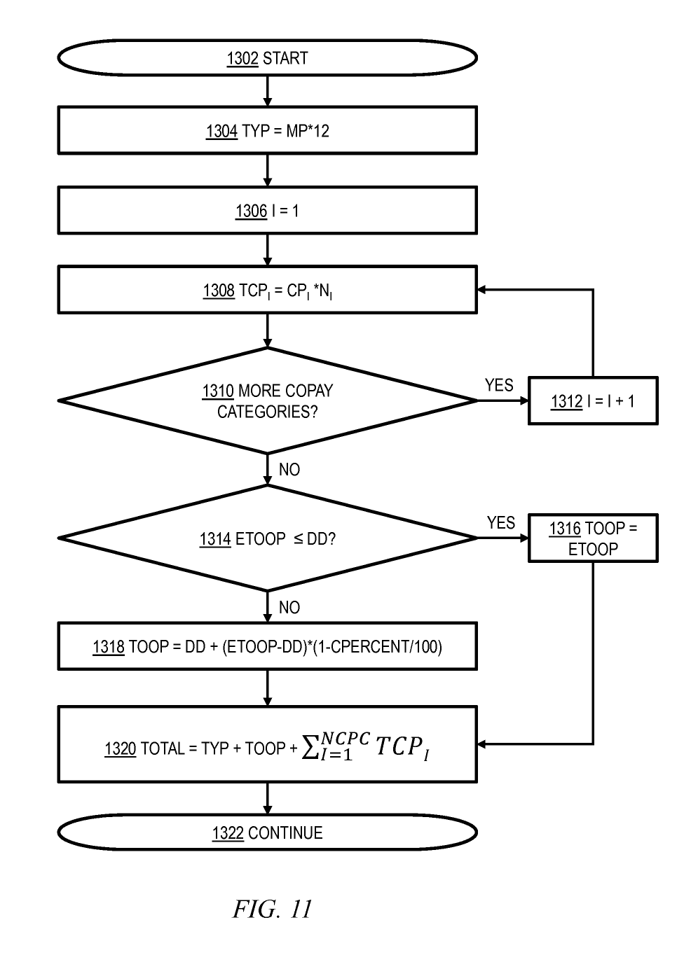

Optimization can be carried out, for example, using a suitable optimization module 308. In some cases, the optimization module implements a decision tree; however, a number of alternative approaches could be used (e.g., do calculations in FIG. 11 for every available plan and pick one with lowest overall cost). FIG. 6 shows an exemplary decision tree approach. Elements similar to those in the other figures have received the same reference character. Such an approach can be implemented, for example, via “fuzzy” statistical analysis within the SAS software suite available from SAS Institute Inc., Cary, N.C., US. Some embodiments use a TURF simulator such as those available from SURVEY ANALYTICS LLC and QuestionPro Inc., both of Seattle, Wash., USA.

Still referring to FIG. 6, one or more embodiments make use of customer profile 302, based on querying transaction database(s) 2021 and/or 1099 (e.g., 1097 and/or 1095) (e.g., subject likes extreme winter sports or eats and drinks large amounts of unhealthy foods and beverages). Again, in some cases, transaction database 2021 and/or 1099 (e.g., 1097 and/or 1095) could be used directly without developing profile(s) 302. Furthermore, one or more embodiments make use of insurance database 304, which includes data supplied by insurance companies and/or data self-reported by the subject. One or more embodiments utilize database management system 306 to profile the opted-in customers 397 of each insurance plan. Exemplary results of such a profiling process include a customer view 604 and/or a plan view 605.

In the customer view aspect shown at 604, an analysis is carried out to determine the distribution of plans for people having (for example) eating and drinking profiles similar to that of the subject. The horizontal axis shows each available insurance plan (may be arranged to obtain a normal curve as shown) and the vertical axis shows the number of people with a similar eating and drinking profile who have signed up for that insurance plan. Optionally, the vertical axis also shows the number of people with a similar eating and drinking profile who have signed up for that insurance plan and are satisfied with it; or alternatively, the vertical axis only shows the number of people with a similar eating and drinking profile who have signed up for that insurance plan and are satisfied with it. In a non-limiting example, identify as candidate plans those plans which are within two standard deviations (or other predetermined interval) of the mean, as seen at 699. The skilled artisan will of course appreciate that for a normal distribution, plus or minus one standard deviation from the mean will account for 68.2% of the set, plus or minus two standard deviations from the mean will account for 95.4% of the set, and plus or minus three standard deviations from the mean will account for 99.7% of the set. Given the teachings herein, the skilled artisan will be able to select the number of standard deviations above and below the mean to return an appropriate number of candidate plans (e.g. based on statistically significant sample size). The vertical dashed line shows the mean.

Some embodiments index against the baseline of the number of accounts in each plan. For example, and referring again to the above discussion of selecting the appropriate number of standard deviations from the norm, suppose in one group of people 15% have one plan, and in another group of people 15% also have the same plan, then 15% will be an index baseline. If there is a plan that 30% of the people have, that would be considered as much more popular than normal. This procedure could be used to normalize how many different plans each of the groups have.

Within the predetermined number of plans, one or more embodiments will determine for each plan the average out-of-pocket spending amount. Generally, the lower the amount of out-of-pocket spending, the more appropriate the coverage is for the corresponding plan for the particular subject. Within the predetermined number of plans, one or more embodiments will also determine for each plan the average cost in terms of premiums. Generally, the lower the cost in terms of premiums, the more appropriate the coverage is for the corresponding plan for the particular subject. One or more embodiments identify the plans with the lowest overall cost, i.e., the lowest total of premiums plus projected out of pocket responsibilities. One, or a few, plans commonly used by people with a similar profile and having low overall cost are then suggested for the subject.

In the plan view aspect shown at 605, an analysis is carried out to determine the distribution of customers within the plans; for example, to determine the distribution of customers for a certain plan, “Plan A.” The curve plots the customer types over an index of the average types of customers. Here, “Plan A” has been selected by many people who pursue extreme winter sports, so it may be inferred that Plan A is preferred by winter sports customers. The horizontal axis shows each category that occurs within insurance “Plan A”—for example, extreme athletes, frequent travelers, allergy sufferers (may be arranged to obtain a normal curve as shown) and the vertical axis shows the number of people within that category for “Plan A.” In a non-limiting example, identify as pertinent categories for “Plan A” those categories which are within two standard deviations (or other predetermined interval) of the mean, as seen at 697. The vertical dashed line is the mean. The skilled artisan will of course appreciate that for a normal distribution, plus or minus one standard deviation from the mean will account for 68.2% of the set, plus or minus two standard deviations from the mean will account for 95.4% of the set, and plus or minus three standard deviations from the mean will account for 99.7% of the set. Given the teachings herein, the skilled artisan will be able to select the number of standard deviations above and below the mean to return an appropriate number of potentially pertinent categories (e.g. based on statistically significant sample size).

In one or more embodiments, the results from the customer view and the plan view are utilized together to identify candidate plans and optimize plan selection with module 308. The results from the customer view and the plan view are compared and aligned to assist in placing subjects in plans that have good coverage and value, and which are preferred by other customers with similar interests.

In another approach, scatter plots rather than normal curves are employed.

In still another approach, referring to the flow chart of FIG. 11, which begins at 1302, simply calculate the projected total annual cost for each available plan. In step 1304, the total yearly premium cost TYP is calculated as the monthly premium MP times 12. See 1212 in FIG. 10. Of course, this calculation can be modified if premium costs are quoted on other than a monthly basis. In step 1306, initialize a counter I. In step 1308, the total yearly amount for the I^{th} kind of co-pay expense, TCP_{I}, is calculated as the product of the co-pay CP_{I} and the estimated number of times the co-pay will be incurred, N_{I}. See 1204, 1206, and 1208 in FIG. 10. As indicated in decision block 1310, if there are additional copay categories, the counter is incremented in step 1312 and logical flow returns to step 1308. In the example of FIG. 10, there are three categories of copay, such that the total number of copay categories NCPC is 3. In the example, CP₁ is 25 and N₁ is 8; CP₂ is 50 and N₂ is 3; and CP₃ is 20 and N₃ is 24.

Once the calculations are complete for all the copay categories, logical flow moves to decision block 1314, where it is determined whether the estimated total out-of-plan spending ETOOP is less than or equal to the out-of-plan deductible DD. If so, then the total out-of plan cost TOOP that will be incurred by the subject is simply ETOOP, as seen at step 1316. On the other hand, if the estimated total out-of-plan spending ETOOP exceeds the out-of-plan deductible DD, then, as seen in step 1318, the total out-of plan cost TOOP that will be incurred by the subject is equal to the deductible plus the amount by which the amount by which the estimated total out-of-plan spending ETOOP exceeds the out-of-plan deductible DD, that is, ETOOP—DD, multiplied by the fraction of the excess that must be paid by the subject, (1−CPERCENT/100). This latter quantity assumes that the plan covers CPERCENT of out-of plan expenses once the deductible is met. For example, if the plan covers 70% of out-of-plan expenses once the deductible is met, the fraction of the excess that must be paid by the subject is 1−70/100=0.3 or 30%. In step 1320, the amounts for the premiums, out of plan, and all the copays are added together to obtain the total. In the non-limiting example of FIG. 10, NCPC is 3, TCP₁ is 200, TCP₂ is 150, and TCP₃ is 480. Processing continues at 1322 (e.g., for the next available plan of interest).

Thus, in one or more embodiments, medical-related and/or lifestyle/activity-related payment card spending is used to make health-related determinations that can be compared to available medical insurance plans (e.g., those provided by an employer) in order to suggest one or more appropriate insurance plans. The user can also consider other medical plans that would fit his or her needs. In one or more embodiments, medical expenses and/or activities (does individual travel, play sports, eat certain types of foods) are used to match an individual to the best fit among the various medical insurance plans he or she has available. This makes it easier for an individual to obtain appropriate insurance coverage. Again, for example, someone who travels a lot will need an insurance that is taken globally; someone who plays a lot of sports will need an insurance plan that has good coverage for sports insurance; someone who is doesn't spend much on doctors and/or medicines will need minimal insurance—only for emergencies.

Of course, all embodiments should comply fully with applicable laws, rules, regulations, policies and procedures designed to protect the security and privacy of health data (for example, in the U.S., The Health Insurance Portability and Accountability Act of 1996 (HIPAA; Pub.L. 104-191, 110 Stat. 1936, enacted Aug. 21, 1996)). Embodiments are intended to be used in full compliance with all applicable laws, regulations, policies, and procedures protecting privacy rights.

### Recapitulation

Given the discussion thus far, it will be appreciated that, in general terms, an exemplary method, according to an aspect of the disclosure, includes data mining (e.g., with DBMS 306) transaction data 1099 and/or 2021 to obtain a health profile for at least one person who wishes to select a medical insurance plan. The transaction data includes at least one of payment card transaction data and electronic bill presentment and payment transaction data. Optionally, the health profile is stored in database 302. A further step includes accessing (e.g., with DBMS 306) a database of insurance information 304 to obtain information on cost and coverage for at least two medical insurance plans available to the at least one person who wishes to select the medical insurance plan. A still further step includes selecting (e.g. with optimization module 308) an optimal one of the at least two medical insurance plans for the person who wishes to select the medical insurance plan, based on the health profile and the information on cost and coverage for the at least two medical insurance plans. This optimal selection can be displayed to the subject, for example, as in FIG. 10.

Where the transaction data includes at least the payment card transaction data, in some cases, a further step includes querying the person who wishes to select the medical insurance plan for at least one payment card account number associated with the person who wishes to select the medical insurance plan. The data mining then includes querying a database 2021 of the payment card transaction data to identify transactions associated with the at least one payment card account number.

In some cases, the data mining further includes examining the transactions associated with the at least one payment card account number for transactions with at least one of health care providers and pharmacies.

In some cases, the data mining further includes examining the transactions associated with the at least one payment card account number for transactions indicating lifestyle factors influencing health.

A further step in some cases includes building the database of insurance information 304 by periodically querying providers 316-1 through 316-N of insurance for a given jurisdiction (e.g., by service provider 314).

On the other hand, a further step in some cases includes building the database of insurance information 304 by querying the person who wishes to select the medical insurance plan.

In some embodiments, a further step includes identifying, in the database of insurance information, insurance plans frequently selected by persons having health profiles similar to the health profile for the at least one person who wishes to select a medical insurance plan (e.g., by analyzing data from the opted-in enrollees 397). In such cases, the selecting of the optimal one of the at least two medical insurance plans is further based on the identification of the insurance plans frequently selected by persons having health profiles similar to the health profile for the at least one person who wishes to select the medical insurance plan. Refer also to the discussion of FIG. 6.

In some cases where the transaction data includes at least the payment card transaction data 2021, the selecting of the optimal one of the at least two medical insurance plans includes carrying out decision tree analysis with the optimization module 308, and the data mining of the payment card transaction data includes the database management system 306 accessing a database 2021 of the payment card transaction data located at an intermediate node in a payment card network 2008.

As described with regard to FIG. 11, in some cases, the step of selecting the optimal one of the at least two medical insurance plans, based on the health profile and the information on cost and coverage for the at least two medical insurance plans, includes calculating a total estimated cost for each of the at least two medical insurance plans, based on the health profile and the information on cost and coverage for the at least two medical insurance plans, and selecting as the optimal one of the at least two medical insurance plans that one of the at least two medical insurance plans having a lowest total estimated cost. This result can be displayed to the subject, as seen in FIG. 10, for example.

In another aspect, transaction data is used for cost estimation purposes and not necessarily for selecting between two or more plans. Thus, another exemplary method, according to another aspect of the invention, includes the step of data mining (e.g., with DBMS 306) transaction data 2021 and/or 1099 to obtain a health profile for at least one person who wishes to estimate costs associated with a medical insurance plan. Optionally, the profile is stored in database 302. A further step includes accessing (e.g., with DBMS 306) a database of insurance information (e.g., 304 but need not have information on more than one plan) to obtain information on cost and coverage for the medical insurance plan. An even further step includes estimating costs (e.g., with an estimation module as discussed elsewhere herein) for the at least one person based on the health profile and the information on cost and coverage for the medical insurance plan. The estimated costs could be displayed, for example, as in FIG. 10; where only cost estimation and not plan selection is taking place, information such as 1202 could be omitted, for example. The calculations could be done, for example, as in FIG. 11.

In another aspect, an exemplary apparatus includes a memory; at least one processor operatively coupled to the memory; and a persistent storage device operatively coupled to the memory and storing in a non-transitory manner instructions which when loaded into the memory cause the at least one processor to be operative to carry out or otherwise facilitate any one, some, or all of the method steps described herein.

As noted, in some cases, an exemplary apparatus includes means for carrying the method steps described herein. Means for data mining transaction data to obtain a health profile can include a database management system (DBMS) module 306 executing on at least one hardware processor. The specific algorithm includes, for example, the specific queries set forth herein. Means for accessing a database of insurance information can also include the database management system (DBMS) module 306 executing on the at least one hardware processor. Means for selecting an optimal one of the at least two medical insurance plans can include an optimization module 308 executing on at least one hardware processor. Exemplary specific algorithms have been described with regard to FIGS. 6 and 11. Means for estimating costs can include an estimation module as discussed elsewhere herein, executing on at least one hardware processor.

SQL or Structured Query Language is a special-purpose programming language designed for managing data held in a relational database management system (RDMS). SQL and RDMS are non-limiting examples of query techniques and database management systems, respectively.

Means for obtaining input and/or displaying or otherwise providing output to a user include user interface module 310, discussed elsewhere herein.

### System and Article of Manufacture Details

Embodiments of the disclosure can employ hardware and/or hardware and software aspects. Software includes, but is not limited to, firmware, resident software, microcode, etc. Software might be employed, for example, in connection with one or more of the tool 399 and its related modules (optimization module 308 and/or DBMS module 306 accessing and/or creating databases 2021, 1099, 302, and/or 304); user interface module 310; a terminal 122, 124, 125, 126; a reader module 132; a host, server, and/or processing center 140, 142, 144 (optionally with data warehouse 154) of a merchant, issuer, acquirer, processor, or operator of a network 2008, operating according to a payment system standard (and/or specification); and the like. Firmware might be employed, for example, in connection with payment devices such as cards 102, 112, as well as reader module 132.

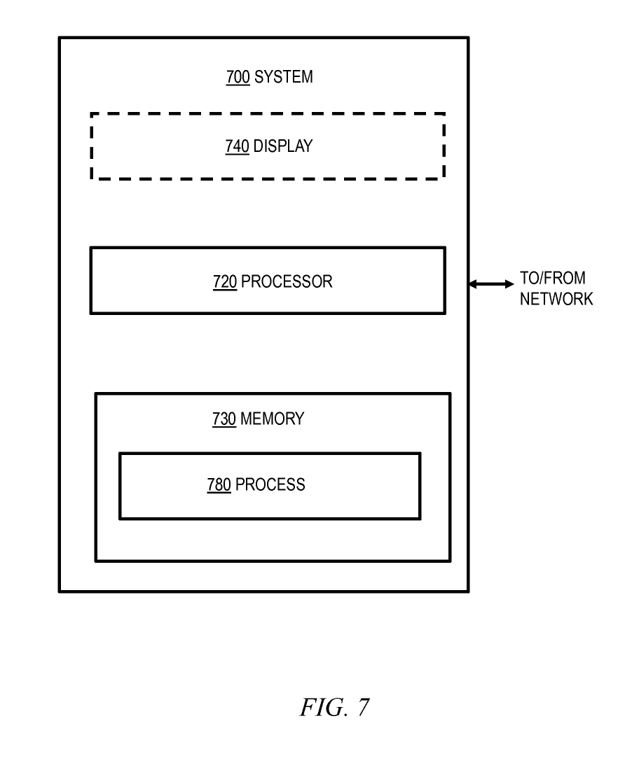

FIG. 7 is a block diagram of a system 700 that can implement part or all of one or more aspects or processes of the disclosure. As shown in FIG. 7, memory 730 configures the processor 720 (which could correspond, e.g., to processor portions 106, 116, 130; a processor of a terminal or a reader module 132; processors of remote hosts in centers 140, 142, 144; processors of hosts and/or servers implementing various functionality such as that of the tool 399 and its related modules (optimization module 308 and/or DBMS module 306 accessing and/or creating databases 2021, 1099, 302, and/or 304); user interface module 310; and the like); to implement one or more aspects of the methods, steps, and functions disclosed herein (collectively, shown as process 780 in FIG. 7). Different method steps can be performed by different processors. The memory 730 could be distributed or local and the processor 720 could be distributed or singular. The memory 730 could be implemented as an electrical, magnetic or optical memory, or any combination of these or other types of storage devices (including memory portions as described above with respect to cards 102, 112). It should be noted that if distributed processors are employed, each distributed processor that makes up processor 720 generally contains its own addressable memory space. It should also be noted that some or all of computer system 700 can be incorporated into an application-specific or general-use integrated circuit. For example, one or more method steps could be implemented in hardware in an ASIC rather than using firmware. Display 740 is representative of a variety of possible input/output devices (e.g., displays, printers, keyboards, mice, touch pads, and so on).

As is known in the art, part or all of one or more aspects of the methods and apparatus discussed herein may be distributed as an article of manufacture that itself comprises a tangible computer readable recordable storage medium having computer readable code means embodied thereon. The computer readable program code means is operable, in conjunction with a computer system, to carry out all or some of the steps to perform the methods or create the apparatuses discussed herein. A computer-usable medium may, in general, be a recordable medium (e.g., floppy disks, hard drives, compact disks, EEPROMs, or memory cards) or may be a transmission medium (e.g., a network comprising fiber-optics, the world-wide web, cables, or a wireless channel using time-division multiple access, code-division multiple access, or other radio-frequency channel). Any medium known or developed that can store information suitable for use with a computer system may be used. The computer-readable code means is any mechanism for allowing a computer to read instructions and data, such as magnetic variations on a magnetic medium or height variations on the surface of a compact disk. The medium can be distributed on multiple physical devices (or over multiple networks). For example, one device could be a physical memory media associated with a terminal and another device could be a physical memory media associated with a processing center. As used herein, a tangible computer-readable recordable storage medium is defined to encompass a recordable medium (non-transitory storage), examples of which are set forth above, but does not encompass a transmission medium or disembodied signal.

The computer systems and servers described herein each contain a memory that will configure associated processors to implement the methods, steps, and functions disclosed herein. Such methods, steps, and functions can be carried out, by way of example and not limitation, by processing capability on one, some, or all of elements 122, 124, 125, 126, 140, 142, 144, 2004, 2006, 2008, 2010; on a computer implementing the tool 399 and its related modules (optimization module 308 and/or DBMS module 306 accessing and/or creating databases 2021, 1099, 302, and/or 304); user interface module 310); and the like. The memories could be distributed or local and the processors could be distributed or singular. The memories could be implemented as an electrical, magnetic or optical memory, or any combination of these or other types of storage devices. Moreover, the term “memory” should be construed broadly enough to encompass any information able to be read from or written to an address in the addressable space accessed by an associated processor. With this definition, information on a network is still within a memory because the associated processor can retrieve the information from the network.

Thus, elements of one or more embodiments of the disclosure, such as, for example, 122, 124, 125, 126, 140, 142, 144, 2004, 2006, 2008, 2010; a computer implementing the tool 399 and its related modules (optimization module 308 and/or DBMS module 306 accessing and/or creating databases 2021, 1099, 302, and/or 304); user interface module 310), and the like, can make use of computer technology with appropriate instructions to implement method steps described herein. Some aspects can be implemented, for example, using one or more servers which include a memory and at least one processor coupled to the memory. The memory could load appropriate software. The processor can be operative to perform one or more method steps described herein or otherwise facilitate their performance.

Accordingly, it will be appreciated that one or more embodiments of the disclosure can include a computer program comprising computer program code means adapted to perform one or all of the steps of any methods or claims set forth herein when such program is run on a computer, and that such program may be embodied on a computer readable medium. Further, one or more embodiments of the present disclosure can include a computer comprising code adapted to cause the computer to carry out one or more steps of methods or claims set forth herein, together with one or more apparatus elements or features as depicted and described herein.

As used herein, including the claims, a “server” includes a physical data processing system (for example, system 700 as shown in FIG. 7) running a server program. It will be understood that such a physical server may or may not include a display, keyboard, or other input/output components. A “host” includes a physical data processing system (for example, system 700 as shown in FIG. 7) running an appropriate program.

Furthermore, it should be noted that any of the methods described herein can include an additional step of providing a system comprising distinct software modules embodied on one or more tangible computer readable storage media. All the modules (or any subset thereof) can be on the same medium, or each can be on a different medium, for example. The modules can include any or all of the components shown in the figures. In one or more embodiments, the modules include a database management system (DBMS) module 306 and an optimization module 308, together forming tool 399; and a user interface module 310 which provides access to the tool. Databases 2021, 1099, 302, 304 are stored in non-volatile (persistent) memory such as a hard drive and accessed by DBMS 306. Output can be provided from UI module 310. The method steps can then be carried out using the distinct software modules of the system, as described above, executing on the one or more hardware processors. Further, a computer program product can include a tangible computer-readable recordable storage medium with code adapted to be executed to carry out one or more method steps described herein, including the provision of the system with the distinct software modules. The user interface module 310 can include, in some cases, a graphical user interface (GUI), such as that formed by a server (in a non-limiting example, operated by service provider 314) serving out hypertext markup language (HTML) code to a browser of a user. The HTML is parsed by the browser on the user's computing device to create a graphical user interface (GUI). In another aspect, the UI module 310 can include an application program interface (API) when one or more techniques disclosed herein are offered as a service to a third party (e.g., issuer 2010 or the like) who accesses the API; the user in such cases may interact, for example, with a GUI provided by the third party. Optimization module 308 can, for example, be a decision tree optimizer using normal curves or scatter plots, or can be an optimizer implementing the logic of FIG. 11 in a high-level language, or the like. Some embodiments use an estimation module. This can simply be the optimization module described herein, used for estimation purposes, or could implement the logic of FIG. 11 in a high-level language for estimation for a single plan without necessarily having any optimization capability.

Some embodiments could employ special-purpose data warehouse appliances and advanced analytics applications for uses including enterprise data warehousing, business intelligence, predictive analytics and business continuity planning, available from Netezza, a subsidiary of International Business Machines Corporation, Armonk, N.Y., USA.

Computers discussed herein can be interconnected, for example, by one or more of network 138, 2008, another virtual private network (VPN), the Internet, a local area and/or wide area network (LAN and/or WAN), via an EDI layer, and so on. Note that element 2008 represents both the network and its operator. The computers can be programmed, for example, in compiled, interpreted, object-oriented, assembly, and/or machine languages, for example, one or more of C, C++, Java, Visual Basic, COBOL, Assembler, and the like (an exemplary and non-limiting list), and can also make use of, for example, Extensible Markup Language (XML), known application programs such as relational database applications, spreadsheets, and the like. Some embodiments make use of SAS software, the Python programming language, and/or the R software environment for statistical computing and graphics. The computers can be programmed to implement the logic depicted in the figures and/or described herein. In some instances, messaging and the like may be in accordance with ISO Specification 5583 Financial transaction card originated messages—Interchange message specifications and/or the ISO 20022 or UNIFI Standard for Financial Services Messaging, also incorporated herein by reference in its entirety for all purposes.

Although illustrative embodiments have been described herein with reference to the accompanying drawings, it is to be understood that those precise embodiments are non-limiting, and that various other changes and modifications may be made by one skilled in the art without departing from the scope or spirit of the disclosure.

What is claimed is:

1. A method comprising the steps of:
data mining transaction data to obtain a health profile for at least one person who wishes to select a medical insurance plan, wherein said transaction data comprises at least one of payment card transaction data and electronic bill presentment and payment transaction data;
accessing a database of insurance information to obtain information on cost and coverage for at least two medical insurance plans available to said at least one person who wishes to select said medical insurance plan; and
selecting an optimal one of said at least two medical insurance plans for said person who wishes to select said medical insurance plan, based on said health profile and said information on cost and coverage for said at least two medical insurance plans.

2. The method of claim 1, wherein, in said data mining step, said transaction data comprises at least said payment card transaction data.

3. The method of claim 2, further comprising querying said person who wishes to select said medical insurance plan for at least one payment card account number associated with said person who wishes to select said medical insurance plan, wherein said data mining comprises querying a database of said payment card transaction data to identify transactions associated with said at least one payment card account number.

4. The method of claim 3, wherein said data mining further comprises examining said transactions associated with said at least one payment card account number for transactions with at least one of health care providers and pharmacies.

5. The method of claim 3, wherein said data mining further comprises examining said transactions associated with said at least one payment card account number for transactions indicating lifestyle factors influencing health.

6. The method of claim 1, wherein, in said data mining step, said transaction data comprises at least said electronic bill presentment and payment transaction data.

7. The method of claim 1, further comprising building said database of insurance information by periodically querying providers of insurance for a given jurisdiction.

8. The method of claim 1, further comprising building said database of insurance information by querying said person who wishes to select said medical insurance plan.

9. The method of claim 1, further comprising identifying, in said database of insurance information, insurance plans frequently selected by persons having health profiles similar to said health profile for said at least one person who wishes to select a medical insurance plan, wherein said selecting of said optimal one of said at least two medical insurance plans is further based on said identification of said insurance plans frequently selected by persons having health profiles similar to said health profile for said at least one person who wishes to select said medical insurance plan.

10. The method of claim 1, wherein:
said data mining of said transaction data is carried out with a database management system module, embodied on a non-transitory computer-readable storage medium, executing on at least one hardware processor;
said accessing of said database of insurance information is carried out with said database management system module, embodied on said non-transitory computer-readable storage medium, executing on said at least one hardware processor; and
said selecting of said optimal one of said at least two medical insurance plans is carried out with an optimization module, embodied on said non-transitory computer-readable storage medium, executing on said at least one hardware processor.

11. The method of claim 10, wherein:
in said data mining step, said transaction data comprises at least said payment card transaction data
said selecting of said optimal one of said at least two medical insurance plans comprises carrying out decision tree analysis with said optimization module; and
said data mining of said payment card transaction data comprises said database management system module accessing a database of said payment card transaction data located at an intermediate node in a payment card network.

12. The method of claim 1, wherein said step of selecting said optimal one of said at least two medical insurance plans, based on said health profile and said information on cost and coverage for said at least two medical insurance plans, comprises calculating a total estimated cost for each of said at least two medical insurance plans, based on said health profile and said information on cost and coverage for said at least two medical insurance plans, and selecting as said optimal one of said at least two medical insurance plans that one of said at least two medical insurance plans having a lowest total estimated cost.

13. A method comprising the steps of:
data mining transaction data to obtain a health profile for at least one person who wishes to estimate costs associated with a medical insurance plan, wherein said transaction data comprises at least one of payment card transaction data and electronic bill presentment and payment transaction data;
accessing a database of insurance information to obtain information on cost and coverage for said medical insurance plan; and
estimating costs for said at least one person based on said health profile and said information on cost and coverage for said medical insurance plan.

14. The method of claim 13, wherein, in said data mining step, said transaction data comprises at least said payment card transaction data.

15. The method of claim 13, wherein, in said data mining step, said transaction data comprises at least said electronic bill presentment and payment transaction data.

16. The method of claim 13, wherein:
said data mining of said transaction data is carried out with a database management system module, embodied on a non-transitory computer-readable storage medium, executing on at least one hardware processor;
said accessing of said database of insurance information is carried out with said database management system module, embodied on said non-transitory computer-readable storage medium, executing on said at least one hardware processor; and
said estimating of said costs is carried out with an estimation module, embodied on said non-transitory computer-readable storage medium, executing on said at least one hardware processor.

17. An apparatus comprising:
a memory;
at least one processor operatively coupled to said memory; and
a persistent storage device operatively coupled to said memory and storing in a non-transitory manner instructions which when loaded into said memory cause said at least one processor to be operative to:
data mine transaction data to obtain a health profile for at least one person who wishes to select a medical insurance plan, wherein said transaction data comprises at least one of payment card transaction data and electronic bill presentment and payment transaction data;
access a database of insurance information to obtain information on cost and coverage for at least two medical insurance plans available to said at least one person who wishes to select said medical insurance plan; and
select an optimal one of said at least two medical insurance plans for said person who wishes to select said medical insurance plan, based on said health profile and said information on cost and coverage for said at least two medical insurance plans.

18. The apparatus of claim 17, wherein said transaction data comprises at least said payment card transaction data.

19. The apparatus of claim 18, wherein said persistent storage device further stores in said non-transitory manner instructions which when loaded into said memory cause said at least one processor to be further operative to query said person who wishes to select said medical insurance plan for at least one payment card account number associated with said person who wishes to select said medical insurance plan, wherein said data mining comprises querying a database of said payment card transaction data to identify transactions associated with said at least one payment card account number.

20. The apparatus of claim 17, wherein said transaction data comprises at least said electronic bill presentment and payment transaction data.

21. The apparatus of claim 17, wherein:
said instructions on said persistent storage device comprise a database management system module and an optimization module;
said at least one processor is operative to data mine said transaction data by executing said database management system module;
said at least one processor is operative to access said database of insurance information by executing said database management system module; and
said at least one processor is operative to select said optimal one of said at least two medical insurance plans by executing said optimization module.

22. An apparatus comprising:
a memory;
at least one processor operatively coupled to said memory; and
a persistent storage device operatively coupled to said memory and storing in a non-transitory manner instructions which when loaded into said memory cause said at least one processor to be operative to:
data mine transaction data to obtain a health profile for at least one person who wishes to estimate costs associated with a medical insurance plan, wherein said transaction data comprises at least one of payment card transaction data and electronic bill presentment and payment transaction data;
access a database of insurance information to obtain information on cost and coverage for said medical insurance plan; and
estimate costs for said at least one person based on said health profile and said information on cost and coverage for said medical insurance plan.

23. The apparatus of claim 22, wherein said transaction data comprises at least said payment card transaction data.

24. The apparatus of claim 22, wherein said transaction data comprises at least said electronic bill presentment and payment transaction data.

25. The apparatus of claim 22, wherein:
said instructions on said persistent storage device comprise a database management system module and an estimation module;
said at least one processor is operative to data mine said transaction data by executing said database management system module;
said at least one processor is operative to access said database of insurance information by executing said database management system module; and
said at least one processor is operative to estimate said costs by executing said estimation module.
